(19) United States
(12) Patent Application Publication
(10) Pub. No.: US 2009/0248584 A1
(43) Pub. Date: Oct. 1, 2009

(54) SYSTEM AND METHOD FOR FACILITATING PAYMENT TO A PARTY NOT HAVING AN ACCOUNT THAT CAN BE USED TO HOLD A MONETARY VALUE EQUIVALENT

(75) Inventors: Martinez-Miranda Eduardo, Pasig City (PH); Enriquez L. Eugene, Pasig City (PH)

Correspondence Address: INTELLECTUAL PROPERTY LAW GROUP LLP, 12 SOUTH FIRST STREET, SUITE 1205, SAN JOSE, CA, 95113, US

(73) Assignee: PAYSETTER PTE LTD, Pasig City (PH)

(21) Appl. No.: 10/597,942

(22) PCT Filed: Feb. 14, 2005
(86) PCT No.: PCT/SG2005/000036

§ 371 Date: Oct. 3, 2006

(30) Foreign Application Priority Data
Feb. 13, 2004 (PH) 1-2004-000064
Jan. 7, 2005 (SG) 200500275-3

(51) Int. Cl. H04L 9/00

(52) U.S. Cl. 705/79

(57) ABSTRACT

A system for facilitating payment to a party not having an account that can be used to hold a monetary value equivalent, including: a payments facilitator; and at least one account established by the payments facilitator operable to hold a monetary value equivalent on trust for its customers. When a payer sends a communication message to the payments facilitator to make a payment to the party, the payments facilitator allocates one of the at least one accounts to the party and links the allocated account with a unique identifier assigned to the party. Payment is thereafter made by the payer to the allocated account. Preferably, the payment is an electronic payment and the account is established with at least one financial institution.

### FIELD OF THE INVENTION

The present invention relates to a system and method for facilitating payment to a party not having an account that can be used to hold a monetary value equivalent. Ideally, the payment is an electronic payment.

### BACKGROUND ART

The following discussion of the background of the invention is intended to facilitate an understanding of the invention. However, it should be appreciated that the discussion is not an acknowledgment or admission that any of the material referred to was published, known or part of the common general knowledge of the person skilled in the art in any jurisdiction as at the priority date of the application.

In some countries, people live on a day-to-day cash basis with little or no capacity for saving money. As a result, a significant portion of these people have no need to establish an account that can be used to hold a monetary value equivalent, such as a bank account. This limits the payment options that can be made to such a person and is thus an inhibitor to the spread of electronic payment services to such people.

Notwithstanding their economic state, a lot of the people referred to in the previous paragraph have mobile telephones which they typically pay for on a pre-paid basis.

Accordingly, it is a primary object of the present invention to provide a system where electronic payments can be made to people who do not have an account that can be used to hold a monetary value equivalent.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is a system for facilitating payment to a party not having an account that can be used to hold a monetary value equivalent, including:
a payments facilitator; and
a plurality of accounts established by the payments facilitator, each account being operable to hold a monetary value equivalent on trust for a customer,
each account of said plurality of accounts having a status of unused, assigned, or inactive;
   where, when a payer sends a communication message to the payments facilitator to make a payment to the party, the payments facilitator allocates one of the unused accounts to the party, changes its status to assigned, and links the allocated account with a unique identifier assigned to the party, the payment thereafter being made by the payer to the allocated account;
   where, when the party redeems the payment, the account status is changed to inactive by the payments facilitator, and subsequently after elapse of a predetermined period of time, the account status is changed to unused by the payments facilitator. Preferably, the payment made by the payer is an electronic payment.

Preferably, the plurality of accounts is established with at least one financial institution.

Ideally, the payments facilitator is, or is associated with, a telecommunications carrier and the unique identifier assigned to the party is the party's telephone number. This may be the party's fixed or mobile telephone number.

Alternatively, the unique identifier may be a code or another destination address, such as the party's e-mail address.

The communication message may take a variety of forms, including Short Messaging Service message; e-mail; telephone call utilising DTMF signals; written communication sent by post; verbal communication. The communication message may also be encrypted.

The communication message may include a variety of information. In one arrangement, the communication message includes the unique identifier of the party, the amount to be transferred to the party and the unique identifier of the payer. In another arrangement, the communication message may include details of the account the payer wishes the payment to be made from.

In alternative arrangements, the destination address of the communication message may be associated with, or include, the unique identifier of the party and/or the amount to be transferred to the party. In such situations, the communication message may not include any information, may only include the amount to be transferred to the party, or may only include the unique identifier of the party (as appropriate).

Preferably, the payments facilitator includes a client database—the primary key of the client database being the unique identifiers of parties/payers alike. The payments facilitator can then use the client database to obtain financial account details of the payer and thus know the account the money is to be paid out of (and whether such account has sufficient credit to make payment).

Optionally, the payments facilitator may request that the payer confirm that the transfer is to proceed by means of a further communication message. The payer may then confirm the transfer by replying to the communication message with a PIN or password (which must match the PIN or password stored in the client database for confirmation to be completed). Confirmation may also need to be attended to within a predefined time period.

The payments facilitator may communicate with the party who has been paid to inform them that money has been transferred to them by the payer. This communication may also specify the amount transferred. The payments facilitator may also communicate with the payer to inform them that the money has been transferred to the party.

Where the at least one account has been established with at least one financial institution, the party may also be informed that the money can be claimed by establishing a bank account with the at least one financial institution. When so established, and details of the established account are notified to the payments facilitator along with the unique identifier of the party, the payments facilitator instructs the financial institution to transfer the money stored on the party's behalf in the associated account with the at least one financial institution having the corresponding unique identifier to the established account. In an ideal arrangement, the established account with the at least one financial institution is also linked to the unique identifier of the party.

Preferably, each transfer is given a trace number to facilitate reconciliation and auditing.

An account status of unused represents the account as being one able to be assigned to a party. An account status of assigned represents the account as being one already assigned to a party. An account status of inactive means that the party has redeemed the payment from the account. The elapse of a predetermined period of time before the account status changes to unused allows time to ensure that any possible fraudulent acts made in connection with the account are dealt with.

In accordance with a second aspect of the present invention there is a payments facilitator for use in a system for facilitating payment to a party not having an account that can be used to hold a monetary value equivalent, the payment facilitator having established a plurality of accounts, each account operable to hold a monetary value equivalent on trust for a customer, each account of said plurality of accounts having a status of unused, assigned, or inactive; and where, upon receipt of a communications message from a payer to make payment to the party, said payment facilitator operates to allocate one of the unused accounts to the party, change its status to assigned, and link the allocated account with a unique identifier assigned to the party, payment thereafter being directed by the payment facilitator to the party's allocated account; where when the party redeems the payment, the payments facilitator operates to change the account status to inactive, and subsequently whereafter elapse of a predetermined period of time said payments facilitator operates to change the account status to unused.

Preferably, the payment facilitator establishes the plurality of accounts with at least one financial institution.

Preferably, the payments facilitator is, or is associated with, a telecommunications carrier and the unique identifier assigned to the party is the party's telephone number. The unique identifier may, as alternatives, be a code or other destination address, such as the party's e-mail address.

The payments facilitator may operate to extract the unique identifier of the party, the amount to be transferred and the unique identifier of the payer from the communication message and/or the destination address to which the communication message is sent. Optionally, the payment facilitator may operate to extract details of the account the payer wishes the payment to be made from and direct that payment be made from the identified account.

Preferably, the payments facilitator includes a client database—the primary key of the client database being the unique identifiers of parties/payers alike. The payments facilitator operable to obtain account details of a payer from the client database by matching unique identifiers and checking that the payer has sufficient credit in their account to make payment.

Ideally, the payments facilitator operates to send a further communication message to the payer requesting confirmation that payment is to be made and operable to make payment on confirmation. The payments facilitator may be operable to confirm payment is to be made by matching a received PIN or password against a PIN or password stored in the client database.

The payments facilitator may, optionally, send a communications message to the party who has been paid on effecting transfer. The payments facilitator may also send a communications message to the payer on effecting transfer.

Where the payments facilitator establishes at least one account with at least one financial institution, the payments facilitator may operate to transfer money from the allocated account to an account established by the party with the at least one financial institution upon receiving details of the established account.

Preferably, the payments facilitator allocates a trace number to each transfer processed.

The payments facilitator may operate to assign a status description of, assigned on allocation of the account to a party; unused where the account is available for allocation to a party; and inactive when the account has been allocated to a party within a previous predetermined time period.

In accordance with a third aspect of the present invention there is a method for facilitating payment to a party not having an account operable to hold a monetary value equivalent, comprising the steps of:
receiving a communication message from a payer representing a request to make a payment to a party;
assigning an unused account established with a financial institution to the party, said account not already being in the name of the party;
directing the payment to be made from the payer to the party to be made to the assigned account;
changing the assigned account status to inactive after the party redeems the payment, and subsequently after elapse of a predetermined period of time, changing the account status to unused.

Preferably, the method includes the further step of establishing a plurality of unused accounts with at least one financial institution.

Preferably, the method includes the further step of identifying from either the communication message and/or a destination address to which the communication message is sent, the following information: the unique identifier of the party; the unique identifier of the payer; and the amount to be transferred.

More preferably, the method includes the further step of identifying from the communication message the account the payer wishes the payment to be made from.

Preferably, the method includes the step of checking the amount available to be transferred in the payer's account, the method continuing if the payer has sufficient amount to make payment.

Preferably, the method includes the step of requesting confirmation from the payer that the transfer is to proceed.

Preferably, the method includes the step of verifying confirmation by comparing a PIN or password provided by the payer as part of confirmation with a previously recorded PIN or password provided by the payer.

Preferably, the method includes the step of communicating with the party who has been paid to inform them that money has been transferred to them by the payer and/or the amount transferred. The method may also include the step of communicating with the payer to inform them that the money has been transferred.

The method may also include the steps of:
receiving details of an account established by the party with a financial institution; and
transferring money held in the allocated account to the established account.

Preferably, the method also includes the step of rendering a previously allocated account inactive for a predetermined period of time before allowing said account to be allocated to another party.

Preferably, the method includes the step of assigning a trace number to each transfer.

In accordance with further embodiments of the invention there is computer-readable means having computer software operable to perform the role of payments facilitator as specified in the second embodiment stored thereon.

### BRIEF DESCRIPTION OF THE DRAWINGS

The invention will now be described with reference to the accompanying drawings, of which:

FIG. 1 is a schematic representation of a system for facilitating payment to a party not having an account with a financial institution.

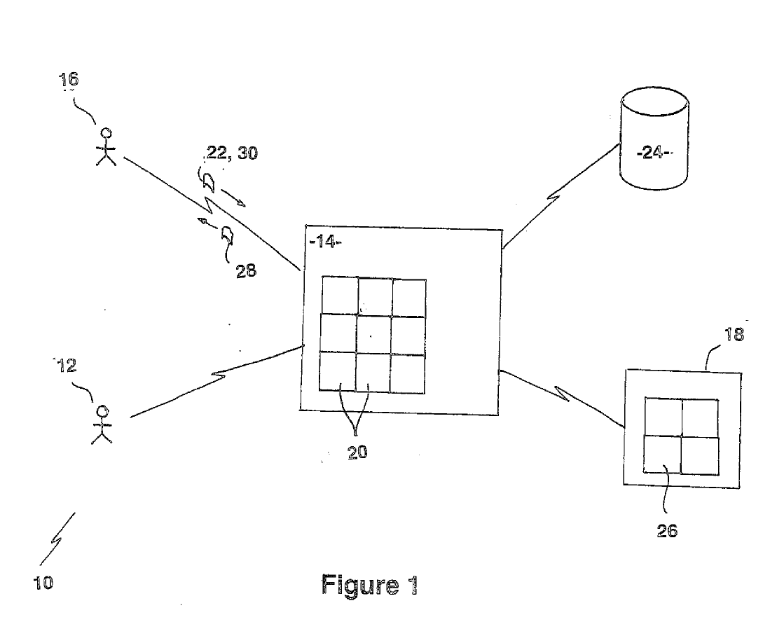

### DETAILED DESCRIPTION OF SPECIFIC EMBODIMENTS

In accordance with a first embodiment of the invention there is system 10 for facilitating electronic payment to a party 12 not having an account that can be used to hold a monetary value equivalent. The system 10 comprises:
a payments facilitator 14; and
a payer 16.

The system 10 will now be described in use.

Payer 16 sends a communication message 22 to the payments facilitator 14. The communication message 22 includes the following information:
The unique identifier of the payer 16;
The amount to be transferred to the party 12; and
The unique identifier of the party 12.

On receipt of the communication message 22, the payments facilitator 14 parses the communication message 22 to identify the unique identifier of the payer 16, the unique identifier of the party 12 and the amount to be transferred.

The payments facilitator 14 then operates to check the unique identifier of the party 12 and the unique identifier of the payer 16 against a client database 24 (the unique identifier of the party 12/payer 14 being the primary key of the records stored in the client database 24). Upon identifying the payer's 16 corresponding record in client database 24, the payments facilitator 14 obtains details from the corresponding record of an associated account. Using these details, the payments facilitator 14 checks whether the payer 16 has sufficient credit in their associated account to effect the transfer.

If the payer 16 does not have sufficient credit in their associated account to effect the transfer, the payments facilitator 14 notifies the payer 16 of this fact.

If the payer 16 has sufficient credit in their associated account to effect the transfer, the payments facilitator 14 may, optionally, send a communications message 28 to the payer 16 requesting confirmation of the transfer. In such circumstances, confirmation of the transfer requires the payer 16 to send a further communication message 30 including a personal identification number (“PIN”) back to the payments facilitator 14. The payments facilitator 14 then compares the communicated PIN with a PIN stored in the payer's 16 corresponding record—confirmation occurring on a match between the two PINs.

If the payer 16 has sufficient credit in their associated account to effect the transfer and has entered a matching PIN, the payments facilitator 14 undertakes a check of the party's 12 corresponding record for details of an associated account. If an associated account is identified, the payments facilitator 14 operates to make an electronic payment equal to the amount to be transferred to the associated account.

If the corresponding record does not include details of an associated account, the payments facilitator 14 operates to associate the corresponding record with one of the payments facilitator's 14 accounts 20 having an assigned status of unused. This association is again based on the unique identifier of the party 12. The associated account 20 is then assigned a status of assigned. The payments facilitator 14 then operates to make an electronic payment equal to the amount to be transferred to the associated account 20. The payments facilitator 14 may then, optionally, notify the payer 16 that the money has been electronically transferred to the party 12.

At the same time, or shortly thereafter, the payments facilitator 14 notifies the party 12 that money has been electronically transferred to them and is being stored in the associated account 20. Simultaneously, the payments facilitator 14 may, optionally, notify the payer 16 that the money has been electronically transferred to the party 12.

Once the monetary value equivalent held in the associated account 20 reaches zero, the account is assigned a status of inactive. The payments facilitator 14 records the date of assigning an inactive status to the associated account 20. In this manner, the payments facilitator 14 can operate to automatically update the status of the associated account 20 to unused following a predetermined period of time from such date.

By having this pool of unused, inactive and assigned accounts 20 the payments facilitator 14 can reuse accounts as needed. The period of time that an account 20 must be assigned the status of inactive can vary, however, it must be of sufficient time to ensure that all monetary value is in fact cleared from the account and to allow time to deal with any possible fraudulent acts made in connection with the account.

If the payments facilitator 14 does not recognise the unique identifier of the party 12, the payer 16 is sent a communications message informing them of this fact and asking them to check the unique identifier of the party 12 entered is correct.

By utilising this system, the payment facilitator 14 can generate revenue by setting transfer fees for operating this system, which may be debited from the amount to be paid to the party 12 either during the initial electronic payment transfer or later upon transfer to their established account 26. The payments facilitator 14 can generate a further revenue stream by appropriating the interest that accrues on unclaimed electronic payments stored in their accounts 20.

It should be appreciated by the person skilled in the art that the invention is not limited to the embodiments described. In particular, the invention described in the first embodiment of the invention can include the following modifications and/or additions:
The associated accounts 20 may be established with a financial institution 18. Similarly, the associated account of the payer from which the money is transferred may be established with a financial institution. In such an arrangement, the payments facilitator 14 may notify the party 12 that the money can be claimed by establishing an account 26 with the financial institution 18 and associating that account 26 with the unique identifier recorded with the payment's facilitator 14. When the party 12 then establishes account 26 and associates the account 26 with their unique identified recorded with the payments facilitator 14, the payments facilitator 14 then operates to instruct the financial institution 18 to transfer the amount stored in associated account 20 to account 26. Following transfer, the amount stored in associated account 20 to account 26, the associated account 20 remains active, but is assigned a status of inactive.
The payer 16 and party 12 may associate their respective accounts with their respective financial institutions using the method described by the applicant in PCT/SG02/00172.
The party 12 may also associate their account 26 with their unique identifier recorded with the payments facilitator 14 by sending a communication message to the payments facilitator 14 including their unique identifier. This message may also include a PIN or password which is subsequently recorded in the party's corresponding record in database 24.
The communication message may be adapted in a variety of ways. For example, the communication message may identify which of a plurality of accounts associated with the payer 16 the payer 16 wishes the payment to be made from. Payment processing is then modified in a manner as would be apparent to the person skilled in the art to ensure that payment is made from the identified associated account.
The communication message may also be adapted to simply include the unique identifier of the party 12. In such an arrangement, the unique identifier of the payer 16 can be obtained through automatic identification of the sending address, such as mobile phone number or e-mail address, used to send the communication message. Similarly, in such an arrangement, the amount to be transferred can be an attribute of, or suffix to, the destination address, such as phone number or e-mail address, to which the communication message is sent. To elaborate, a plurality of telephone lines could be used with each telephone line representing a different amount to be transferred. In such arrangement, the telephone number associated with the line could include as part of the dialled digits, the amount to be transferred (eg. shortcode 110 could be used by customers to transfer 110). This arrangement then provides the payer 16 with an easy reference to assist them in ensuring that they send the communication message using the telephone line corresponding to the amount that they wish to transfer.
The communication message may be yet further adapted to simply identify the amount to be transferred. In such an arrangement, the unique identifier of the payer 16 can be obtained through automatic identification of the sending address, such as mobile phone number or e-mail address, used to send the communication message. Similarly, in such an arrangement, the telephone number dialled may be a combination of a short code number and the unique identifier of the party 12 to whom the amount is to be transferred. Payments facilitator 14 then operates to parse the dialled telephone number to obtain the unique identifier of the party 12 and convert it into a native format for use in subsequent processing.
The methods of communication/notification may take a variety of forms including Short Messaging Service message; e-mail; telephone call utilising DTMF signals; written communication sent by post; verbal communication.
In situations where the payer 16 enters details of either the amount to be transferred and/or the unique identifier of the party 12 using the telephone keypad, the system as described may be adapted to allow the payer 16 to do so without needing to wait for prompts from an automated system designed to receive such information. Instead, the payer 16 may be able to split the dialled tones representing the amount to be transferred from the dialled tones representing the unique identifier of the party 12 using an appropriate separator key—such as the “*” or “#” keys.
The communication messages and notifications may be encrypted. In such situations, at least the payments facilitator 16 must be equipped with means for encrypting and decrypting messages.
The unique identifier of the payer 16 and party 12 may be their destination address. Ideally, this is their mobile phone number. In such situations automatic caller identification or other mechanisms performing a similar function can be used to establish the unique identifier of the payer 16.
The payments facilitator 14 may form part of a larger computer system operated by a telecommunications carrier.
The payer 16 can confirm a transfer is to proceed by entry of a password, which may be alphabetic or alphanumeric.
Each transfer may be given a trace number to facilitate reconciliation and auditing.

It should be yet further appreciated by the person skilled in the art that variations and combinations of features described above, not being alternatives or substitutes, can be combined to form yet further embodiments falling within the intended scope of the various embodiments of the invention.

1. A system for facilitating payment to a party not having an account that can be used to hold a monetary value equivalent, including:
a payments facilitator; and
a plurality of accounts established by the payments facilitator, each account being operable to hold a monetary value equivalent on trust for a customer;
each account of said plurality of accounts having a status of unused, assigned, or inactive;
where, when a payer sends a communication message to the payments facilitator to make a payment to the party, the payments facilitator allocates one of the unused accounts to the party, changes its status to assigned, and links the allocated account with a unique identifier assigned to the party, the payment thereafter being made to the allocated account;
where, when the party redeems the payment, the account status is changed to inactive by the payments facilitator, and subsequently after elapse of a predetermined period of time, the account status is changed to unused by the payments facilitator.

2. A system for facilitating payment according to claim 1, where the plurality of accounts are established with at least one financial institution.

3. A system for facilitating payment according to claim 1 or claim 2, the payments facilitator being, or being associated with, a telecommunications carrier.

4. A system for facilitating payment according to any preceding claim, where the unique identifier assigned to the party is selected from one of the party's mobile phone number; the party's fixed telephone number; the party's e-mail address.

5. A system for facilitating payment according to any preceding claim, where the unique identifier of the party is included in, or can be attained from, the communication message or the destination address to which the communication message is sent.

6. A system for facilitating payment according to any preceding claim, where the unique identifier of the payer is included in, or can be attained from, the communication message or the destination address to which the communication message is sent.

7. A system for facilitating payment according to any preceding claim, where the amount to be paid is included in, or can be attained from, the communication message or the destination address to which the communication message is sent.

8. A system for facilitating payment according to any preceding claim, where the payments facilitator includes a client database, the primary key of records stored in the client database being the unique identifier of the party.

9. A system for facilitating payment according to claim 8, where each record in the client database includes financial account details of the party to which the record relates.

10. A system for facilitating payment according to any preceding claim, where the payments facilitator sends a first additional communication message to the payer requesting confirmation of the transfer and receives a second additional communication message from the payer confirming the transfer.

11. A system for facilitating payment according to claim 10, where the second additional communication message includes a PIN or password, the transfer proceeding if the communicated PIN or password matches a pre-stored PIN or password recorded for the payer.

12. A system for facilitating payment according to claim 10 or claim 11, where the payer is required to send the second additional communication message within a predetermined time period for the transfer to proceed.

13. A system for facilitating payment according to any preceding claim, where the payments facilitator sends a third additional communication message to the party informing them of the transfer.

14. A system for facilitating payment according to any preceding claim, where the payments facilitator sends a fourth additional communication message to the payer confirming the transfer has taken place.

15. A system for facilitating payment according to any one of claims 2 to 14, as dependent on claim 2, where the fourth additional communication message includes text informing the party that the money can be claimed by establishing a bank account with the at least one financial institution.

16. A system for facilitating payment according to claim 15, where, when the party establishes an account with the at least one financial institution, the payments facilitator operates to transfer the money stored in the associated account to the established account.

17. A payments facilitator for use in a system for facilitating payment to a party not having an account that can be used to hold a monetary value equivalent, the payments facilitator having established a plurality of accounts, each account operable to hold a monetary value equivalent on trust for a customer, each account of said plurality of accounts having a status of unused, assigned, or inactive; where, upon receipt of a communications message from a payer to make payment to the party, said payment facilitator operates to allocate one of the unused accounts to the party, change its status to assigned, and link the allocated account to a unique identifier assigned to the party, the payments facilitator thereafter operating to direct payment to the allocated account; where when the party redeems the payment, the payments facilitator operates to change the account status to inactive, and subsequently whereafter elapse of a predetermined period of time said payments facilitator operates to change the account status to unused.

18. A payments facilitator according to claim 17, where the payments facilitator establishes the plurality of accounts with at least one financial institution.

19. A payments facilitator according to claim 17 or claim 18, operable to assign the party's phone number as the unique identifier.

20. A payments facilitator according to any one of claims 17 to 19, operable to extract the unique identifier of the party from the communication message and/or the destination address to which the communication message is sent.

21. A payments facilitator according to any one of claims 17 to 20, operable to extract the unique identifier of the payer from the communication message and/or the destination address to which the communication message is sent.

22. A payments facilitator according to any one of claims 17 to 21, operable to extract the amount to be transferred from the communication message and/or the destination address to which the communication message is sent.

23. A payments facilitator according to any one of claims 17 to 22, including a client database, the payments facilitator operable to obtain financial account details of a payer from the client database.

24. A payments facilitator according to any one of claims 17 to 23, operable to send a first additional communication message to the payer requesting confirmation that the payment is to be paid and operable to proceed with the payment on receiving a second additional communication message from the payer providing such confirmation.

25. A payments facilitator according to claim 24, operable to extract a PIN or password from the second additional communication message and, where the communicated PIN or password matches a pre-stored PIN or password fro the payer, proceeding with the payment.

26. A payments facilitator according to any one of claims 17 to 25, operable to send a third additional communication message to the payer confirming payment on effecting payment.

27. A payments facilitator according to any one of claims 17 to 26, operable to send a third additional communication message to the party confirming payment on effecting payment.

28. A payments facilitator according to any one of claims 18 to 27, as dependent on claim 18, operable to transfer money from the allocated account to an account established by the party with the at least one financial institution upon receiving details of the established account.

29. A method for facilitating payment to a party not having an account that can be used to hold a monetary value equivalent including the steps of:
receiving a communication message from a payer representing a request to make a payment to a party;
assigning an unused account operable to hold a monetary value to the party, said account not already being in the name of the party;
directing the payment to be made from the payer to the party to be made to the assigned account;
changing the assigned account status to inactive after the party redeems the payment, and subsequently after elapse of a predetermined period of time, changing the account status to unused.

30. A method for facilitating payment according to claim 29, including the step of establishing a plurality of unused accounts with a financial institution.

31. A method for facilitating payment according to claim 29 or claim 30, including the additional step of identifying the unique identifier of the party from either the communication message and/or a destination address to which the communication message is sent.

32. A method for facilitating payment according to any one of claims 29 to claim 31, including the additional step of identifying the unique identifier of the payer from either the communication message and/or a destination address to which the communication message is sent.

33. A method for facilitating payment according to any one of claims 29 to 32, including the additional step of identifying the amount to be paid from either the communication message and/or a destination address to which the communication message is sent.

34. A method for facilitating payment according to any one of claims 29 to 33, including the additional step of identifying from the communication message the account the payer wishes the payment to be made from.

35. A method for facilitating payment according to any one of claims 29 to 34, including the step of checking the amount available to be transferred in the payer's account, the method continuing if the payer has sufficient amount to make payment.

36. A method for facilitating payment according to any one of claims 29 to 35, including the step of requesting confirmation from the payer that the transfer is to proceed.

37. A method for facilitating payment according to claim 36, including the step of verifying confirmation by comparing a PIN or password provided by the payer as part of confirmation with a previously recorded PIN or password provided by the payer.

38. A method for facilitating payment according to any one of claims 29 to 37, including the step of communicating with the party who has been paid to inform them that money has been transferred to them by the payer and/or the amount transferred.

39. A method for facilitating payment according to any one of claims 29 to 38, including the step of communicating with the payer to inform them that the money has been transferred.

40. A method for facilitating payment according to any one of claims 30 to 39, as dependent on claim 30, including the additional steps of:
receiving details of an account established by the party with the financial institution; and
transferring money held in the allocated account to the established account.

41.-43. (canceled)
